(19) United States
(12) Patent Application Publication
(10) Pub. No.: US 2017/0145273 A1
(43) Pub. Date: May 25, 2017

(54) LEAK REPAIR COMPOSITIONS AND METHODS

(71) Applicant: Jay A. Savicky, Corona, CA (US)

(72) Inventor: Jay A. Savicky, Corona, CA (US)

(21) Appl. No.: 15/332,453

(22) Filed: Oct. 24, 2016

Related U.S. Application Data
(60) Provisional application No. 62/259,375, filed on Nov. 24, 2015.

(51) Int. Cl. C09K 3/12; F16L 55/164; B05D 7/24; B05D 3/00; C09D 1/02; B05D 1/30

(52) U.S. Cl. CPC C09K 3/12; C09D 1/02; B05D 1/30; B05D 7/24; B05D 3/002; F16L 55/164; B05D 2201/02; B05D 2202/45

(57) ABSTRACT

A sodium silicate solution and fiber composition for repairing leaks in plumbing, and methods of making and using the same.

### CROSS-REFERENCE TO RELATED APPLICATIONS

This application claims the benefit of U.S. Provisional Application No. 62/259,375, filed Nov. 24, 2015, which is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

1. Field of the Invention

The invention relates generally to repair of plumbing systems and more specifically to fixing leaks, holes, or cracks in plumbing systems.

2. Description of the Related Art

Sodium silicate is known to be used in the repair of metal and other material in plumbing, such as for the sealing of leaks in pipes. Sodium silicate may be used in a solution, which may then be applied to the metal or other material to be repaired. However, a sodium silicate solution used alone may be used to repair a hole only up to approximately ⅛ inch, and may not be strong enough to fix leaks caused by holes or cracks larger than ⅛ inch in pipes. Thus, there is a need for a strong product that can easily be applied to metal or other material for repair of large holes or cracks.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect a sodium silicate solution is combined with fiberglass fibers and glass spheres and mixed together. Thus, an advantage is that the sodium silicate solution may be strengthened or reinforced by the added fibers and spheres, and larger leaks can be fixed than could be fixed with a sodium silicate solution alone.

In another aspect sodium silicate in a solution is combined with Kevlar®, carbon, or wood fibers and glass spheres and mixed together. An advantage may be that any fibers or glass spheres added may help to reinforce the sodium silicate.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIGS. 1a-1b show examples of 1/32 inch milled fiberglass fibers that may be mixed with a sodium silicate solution to make a leak repair composition, according to an aspect.

FIG. 1c shows an example of 1/16 inch milled fiberglass fibers that may be mixed with a sodium silicate solution to make a leak repair composition, according to an aspect.

FIGS. 1d-1e show examples of ¼ inch chopped fiberglass fibers that may be mixed with a sodium silicate solution to make a leak repair composition, according to an aspect.

FIG. 2 shows an example of glass spheres that may be mixed with a sodium silicate solution, according to an aspect.

FIG. 3a shows examples of a sodium silicate solution product that may be used for making a leak repair composition, and examples of fibers that may be mixed with the sodium silicate, according to an aspect.

FIG. 3b shows an example of a sodium silicate solution product that may be used for making a leak repair composition, according to an aspect.

FIG. 4 shows a sodium silicate solution made with three sizes of fiberglass fibers mixed in: the 1/32-inch milled fibers, 1/16-inch milled fibers, and ¼-inch chopped fibers, according to an aspect.

FIG. 5 is a flow chart illustrating an example of an exemplary process for making a leak repair composition, according to an aspect.

FIG. 6 shows an example of a thixotropic silica product that may optionally also be added to the leak repair composition, according to an aspect.

FIG. 7 shows a leak repair composition, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled elements across the figures (e.g., 405 and 705, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

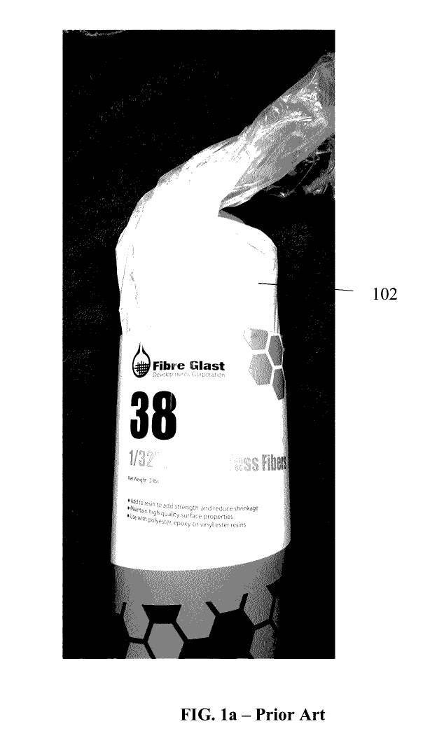

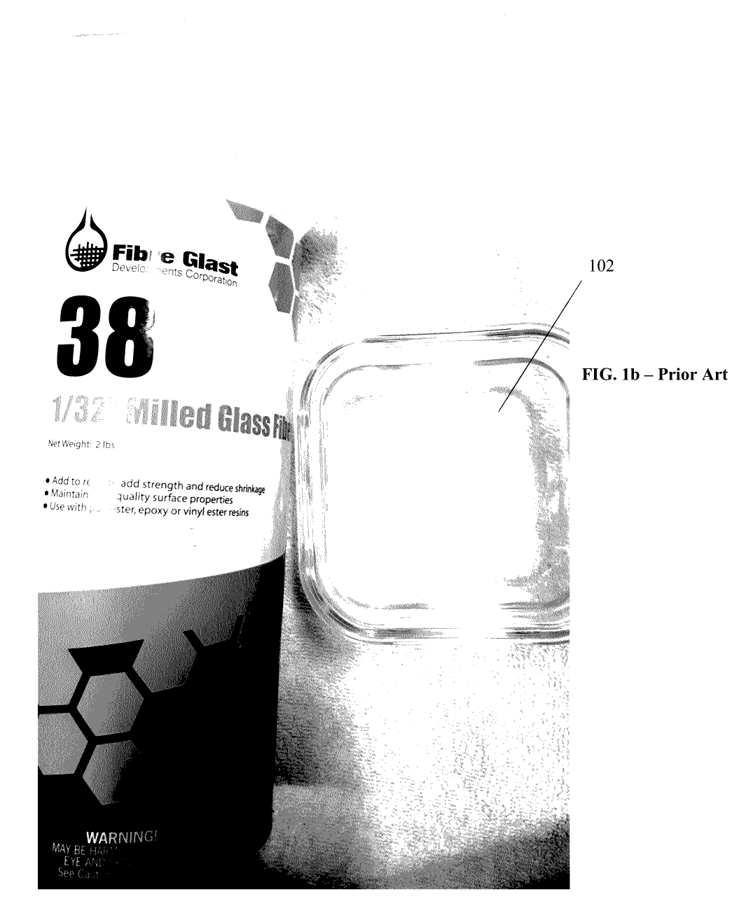

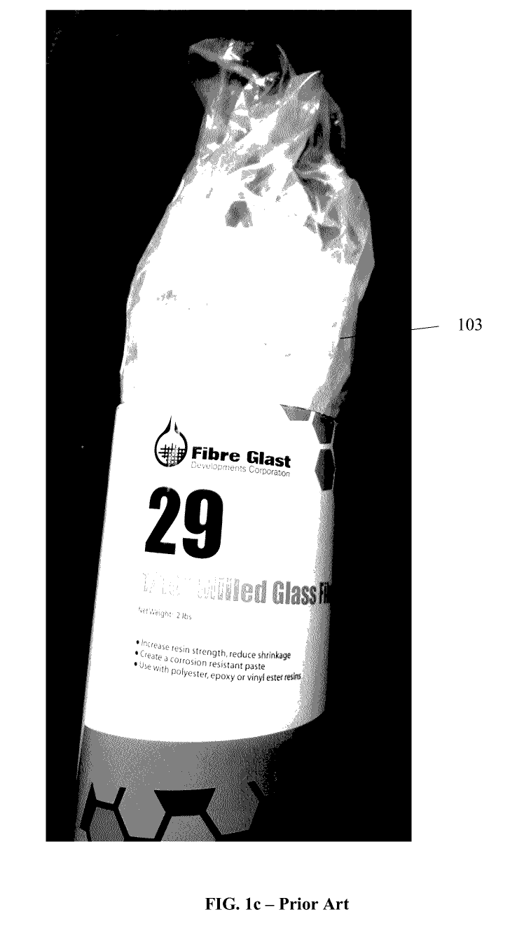

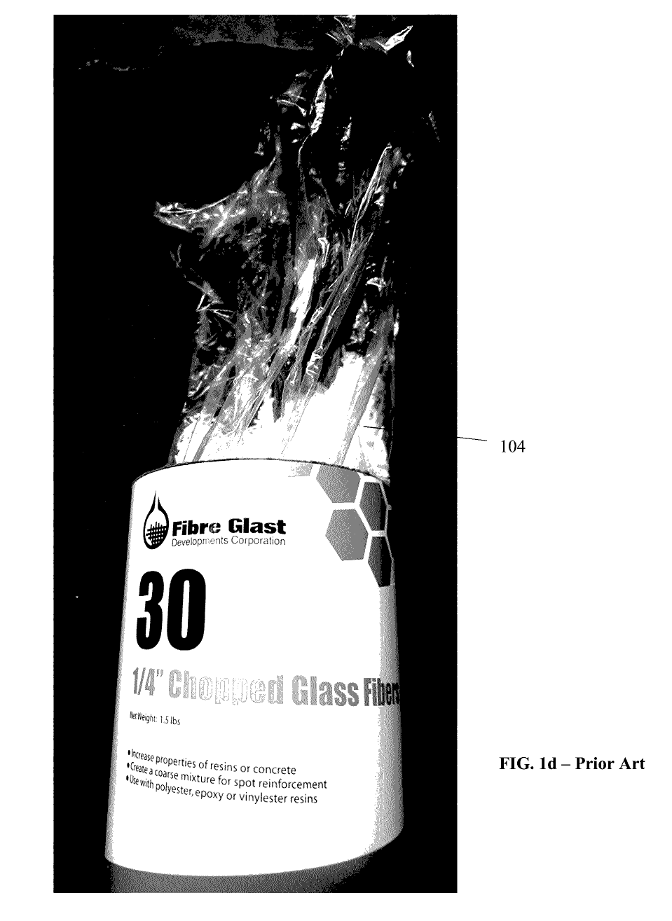

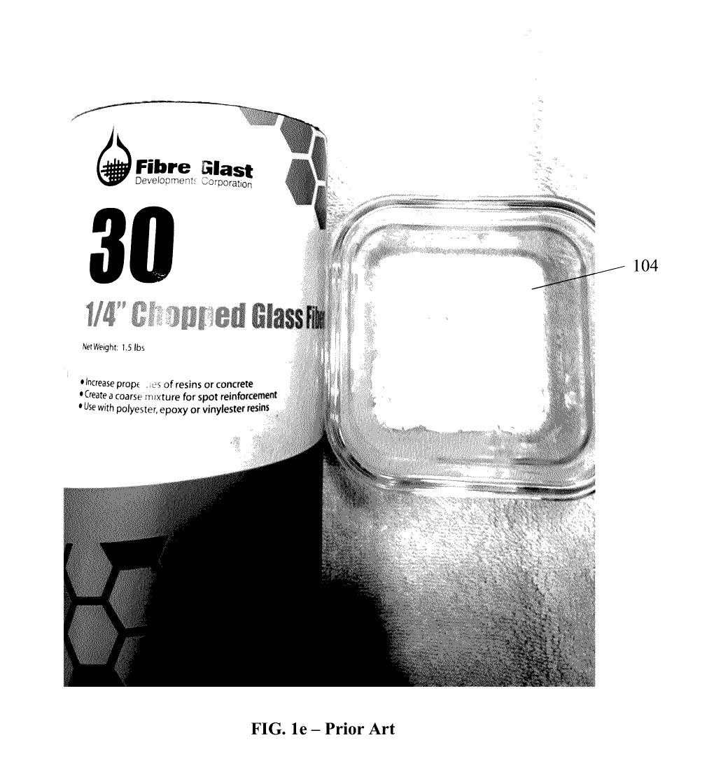

FIGS. 1a-1b show examples of 1/32 inch milled fiberglass fibers 102 (“fiberglass fibers,” “fibers,” or “fiberglass”) that may be mixed with a sodium silicate solution to make a leak repair composition, according to an aspect. The leak repair composition may be used to repair or patch holes or weakened areas in plumbing systems, such as pipes, suction lines, spa jets, and the like. The leak repair composition made with a mixture of sodium silicate and fiberglass may be thicker and stronger than sodium silicate solution alone used for leak repair. Various sizes of fiberglass fibers may be used together. As shown as an example of products that may be used in making a leak repair composition, the fibers may be produced by Fibre Glast Developments Corporation. The fibers may also be, for example, Kevlar®, carbon, wood, or any other suitable material.

FIG. 1c shows an example of 1/16 inch milled fiberglass fibers 103 that may be mixed with a sodium silicate solution to make a leak repair composition, according to an aspect. As an example, the product may be manufactured by Fibre Glast Developments Corporation.

FIGS. 1d-1e show examples of ¼ inch chopped fiberglass fibers 104 that may be mixed with a sodium silicate solution to make a leak repair composition, according to an aspect. Again, as an example, the product may be manufactured by Fibre Glast Developments Corporation.

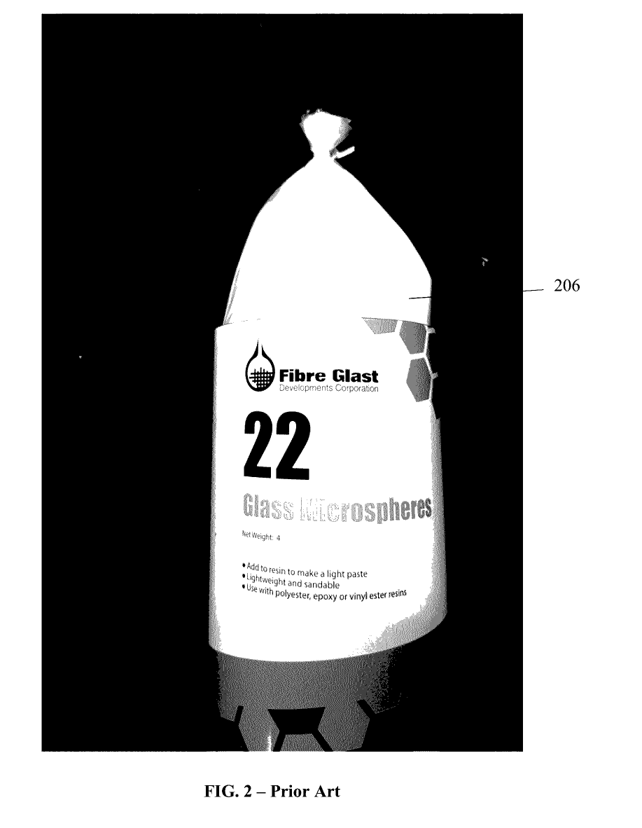

FIG. 2 shows an example of glass spheres 206 (“glass spheres,” or “glass microspheres,” or “spheres”) that may be mixed with a sodium silicate solution, according to an aspect. As shown in FIG. 2 as an example, the product may be glass microspheres 206, produced by Fibre Glast Developments Corporation.

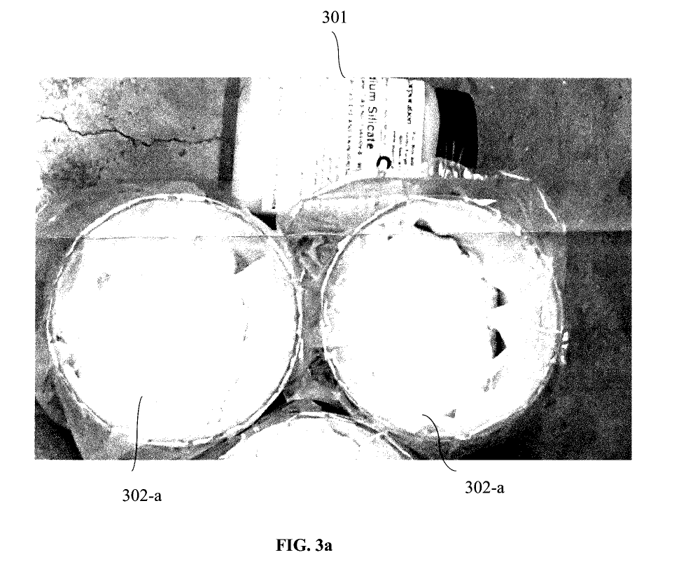

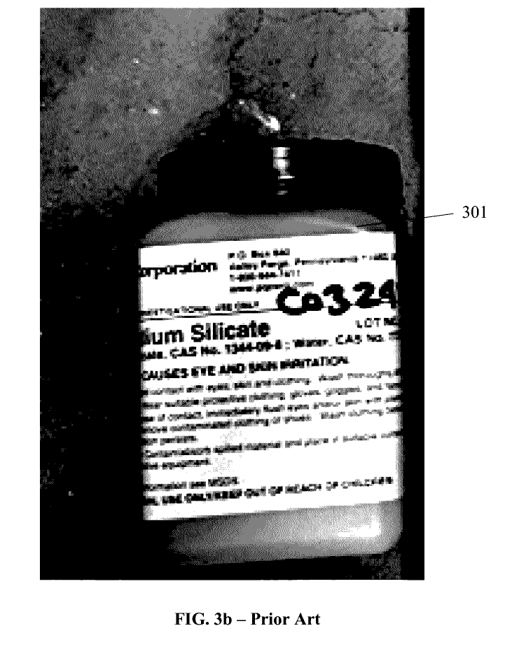

FIG. 3a shows examples of a sodium silicate solution product 301 that may be used for making a leak repair composition, and examples of fibers 302-a that may be mixed with the sodium silicate 301, according to an aspect. As an example, sodium silicate solution as manufactured by PQ Corporation may be used.

FIG. 3b shows an example of a sodium silicate solution product that may be used for making a leak repair composition, according to an aspect. The addition of fibers to the sodium silicate solution may strengthen the solution by building a matrix screen packed around the holes and/or cracks to be repaired. Fibers and spheres added to the sodium silicate solution may give the sodium silicate a framework to adhere to such that the composition can be used to repair a much larger hole than can be repaired with sodium silicate alone. The fibers may also increase the strength of the sodium silicate composition, such as, for example, by acting similarly as reinforcing bars in concrete.

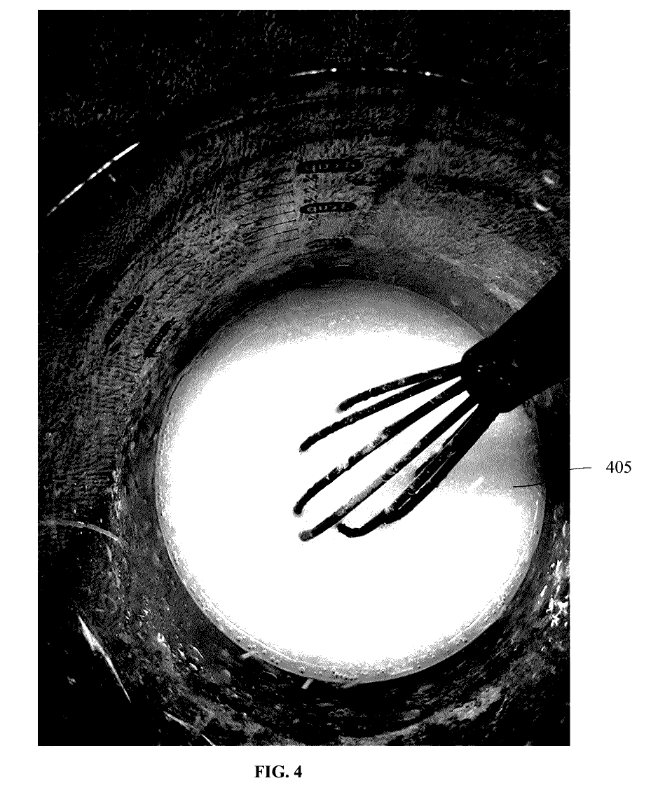

FIG. 4 shows a sodium silicate solution 405 made with three sizes of fiberglass fibers mixed in: the 1/32-inch milled fibers 102, 1/16-inch milled fibers 103, and ¼-inch chopped fibers 104, according to an aspect. In another aspect, glass spheres 206 may also be mixed into the solution 405 for added reinforcement. In another alternative embodiment, the fibers used may be composed of Kevlar®, carbon, wood, or any other suitable material that give the characteristics of strengthening the sodium silicate composition. Any suitable combination of fiber materials or sizes of milled or chopped fiberglass may also be used in the sodium silicate composition.

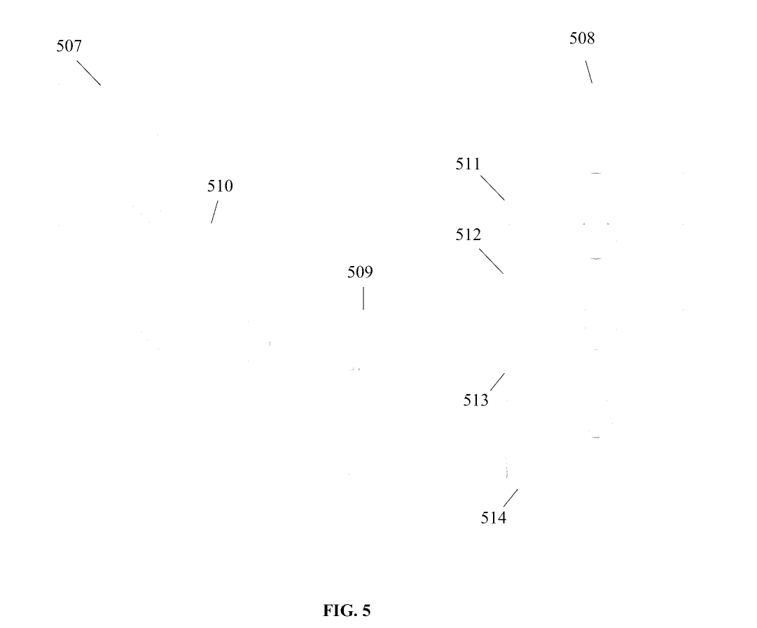

FIG. 5 is a flow chart illustrating an example of an exemplary process for making a leak repair composition, according to an aspect. To make the leak repair composition 405, the following process may be followed. Two parts “Leak cure part A” 507 and “Leak cure part B” 508 may be combined in a ratio of approximately 7 parts “Leak cure part A” to 1 part “Leak cure part B,” to create the leak repair composition “Leak cure final” 510. 28 ounces of a 40% sodium silicate solution may be used as the “Leak cure part A” (step 510). The 40% sodium silicate solution may be available in liquid form having the consistency of syrup and may be used undiluted. “Leak cure part B” (508) may be made by combining 4 ounces of water (step 511), 1 tablespoon of 1/32-inch milled fibers 102 (step 512), 1 tablespoon of 1/16-inch milled fibers 103 (step 513), and 1 tablespoon of ¼-inch milled fibers 104 (step 514). “Leak cure part A” 507 and “Leak cure part B” 508 may then be combined to make 32 ounces of the composition “Leak cure final” (step 509). The fibers are added to the sodium silicate solution and the solution is agitated to mix all components. The mixture is agitated for approximately 1-5 minutes with, for example, a whisk, until a smooth consistency with no lumps is achieved.

In another exemplary process for making a leak repair composition, milled or chopped fiberglass is added to a sodium silicate solution at a ratio of 1 gallon of sodium silicate solution to ¼ cup of each fiber type. Thus, in an example of making a composition to fix smaller leaks, ¼ cup of the 1/32-inch milled fibers 102 and ¼ cup of the 1/16-inch milled fibers 103 are added to one gallon of the sodium silicate solution. In an example of making a composition for fixing larger leaks, the ¼-inch chopped fibers 104 may also be added at a ratio of a tablespoon for every quart of the sodium silicate solution. Again, the mixture is then agitated for approximately 1-5 minutes with, for example, a whisk, until a smooth consistency with no lumps is achieved. Glass microspheres 206 are added at a ratio of 1-2 tablespoons per quart of the sodium silicate solution, and the composition is then mixed; however, the glass microspheres 206 may be unnecessary for some repair jobs, such as, for example, for repairing PVC pipes. The process for making the composition 405 may be carried out at any temperature between 35-115 degrees Fahrenheit, or any other suitable temperatures. The process for making the composition 405 is preferably carried out immediately before use, or up to approximately three days before use. The composition 405 may harden and dry into a glass after approximately 24-72 hours, depending on various environmental factors, such as, for example, humidity and temperature.

In another exemplary process for making a leak repair composition, a 39% solution may be used in step 509, such as, for example, the product 301 shown in FIG. 3, available in liquid form having the consistency of syrup. Again, the 39% sodium silicate solution 301 may be used undiluted.

In another exemplary process for making a leak repair composition, ¼ teaspoon of each size of fiber ( 1/32-inch milled, 1/16-inch milled, and ¼-inch chopped) are combined with approximately 28 ounces of sodium silicate solution. This composition may be used for repairing minor leaks, in which approximately 1 pound of pressure per minute is lost. For leaks larger than this, 1 tablespoon of each size of fiber may substituted for ¼ teaspoon, for example.

In another exemplary process for making a leak repair composition, “Leak cure part B” 508 may be made using fibers of material other than fiberglass, such as Kevlar®, carbon, or wood. These fibers may be milled to the same diameter ( 1/32-inch, 1/16-inch, and ¼-inch) as the fiberglass fibers described in the examples herein.

In another exemplary process for making a leak repair composition, a mixture of fibers (“Leak cure part B”) may be prepared separately from the sodium silicate solution (“Leak cure part A”), such that the two parts may be combined immediately before use. The fibers may be suspended in, for example, water, such that the fibers are kept in suspension and prevented from becoming airborne. The water suspension may also aid the fibers in flowing easily from the bottle when mixing the two parts together and when draining the leak repair composition into the plumbing system, such as a sump pump, to be repaired. As an example, sodium silicate solution may be packaged as “Leak cure part A,” and water, fibers, and glass spheres may be packaged separately as “Leak cure part B,” such that the mixing of sodium silicate, water, fibers, and glass spheres may be done immediately before use. After thoroughly mixing together, the composition 705 may be used for repairing plumbing systems and pipes, such as that of swimming pools or spas. The composition 705 may be used to repair copper, PVC, or any other suitable material. The composition 705 may be, for example, poured in a swimming pool skimmer or added to a sump system, depending on where the repair is needed.

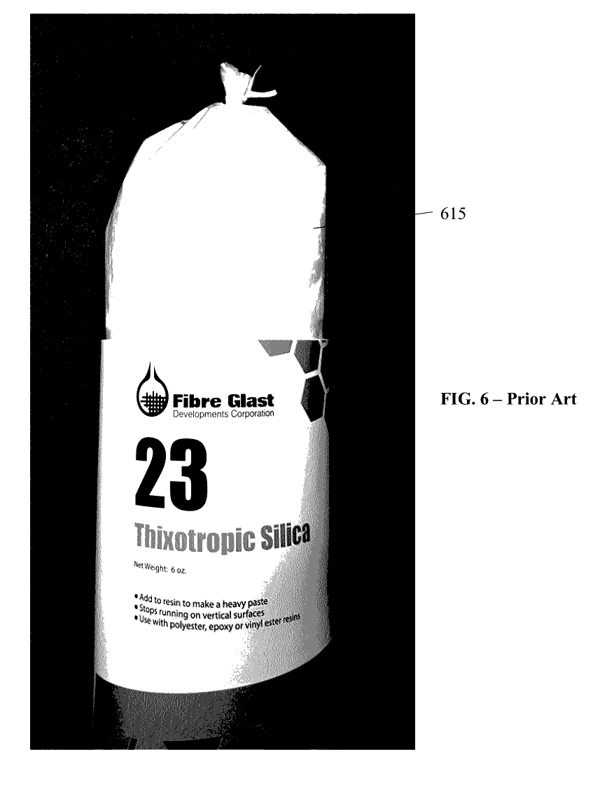

FIG. 6 shows an example of a thixotropic silica product 615 that may optionally also be added to the leak repair composition 405, according to an aspect. A thickening agent, such as the thixotropic silica shown, may also be added and mixed into the composition 405 in order to achieve a thicker consistency of the composition 405, such as, for example, to fix larger leaks or breaks in the plumbing. As examples, the thickening agent may be added at a ratio of ¼ cup of thixotropic silica 615 for every one gallon of sodium silicate solution, or one tablespoon of thixotropic silica 615 for every one quart of sodium silicate solution. As shown as an example of a product that may be used in the making of a leak repair composition 405, the thixotropic silica may be produced by Fibre Glast Developments Corporation.

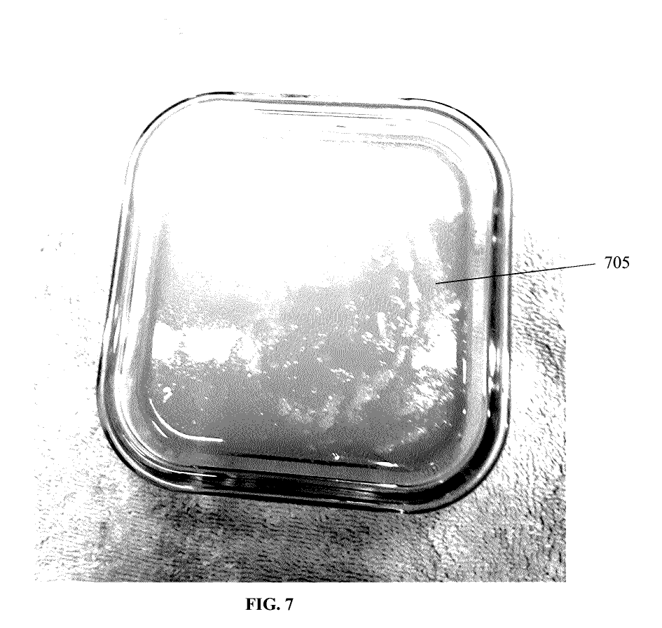

FIG. 7 shows a leak repair composition, made by the process described in FIG. 5, according to an aspect. The leak repair composition, as shown in the example in FIG. 7, may be made with three sizes of fibers, 1/32-inch milled, 1/16-inch milled and ¼-inch chopped. The composition may harden into a glass-like product, such that the area to be repaired is patched by the hardened composition. The composition may preferably be used to repair leaks at least seven days after preparation, before it hardens.

It should be understood that the exemplary processes described herein may be used for repairing plumbing. The following exemplary processes may be followed as alternative exemplary processes.

For a composition to repair PVC pipes, the following process may be followed. ¼ cup of 1/32 inch milled fiberglass, ¼ cup of 1/16 inch milled fiberglass, and 1 tablespoon of ¼ inch chopped fiberglass are added to 1 gallon of sodium silicate solution and mixed together until a smooth consistency is achieved.

For a composition to repair copper plumbing, the following process may be followed. ¼ cup of 1/32 inch milled fiberglass, ¼ cup of 1/16 inch milled fiberglass, 1 tablespoon of ¼ chopped fiberglass, and ¼ cup thixotropic silica are added to 1 gallon of sodium silicate solution and mixed together until a smooth consistency is achieved.

To repair leaking return lines of a pool, the following process may be carried out after making the leak repair composition 705. The filter media is removed from the filter and the recirculating pump is turned on. The composition 705 is poured into the skimmer. The skimmer is then turned off and the suction is set for main drain during the repair process. The pump is operated for 24 hours afterwards, then shut off for three days for the repair to be completed. The previously removed filter media is then replaced and normal operation may resume after it is confirmed that the leak has been fully repaired.

To repair suction lines of a pool, the following process may be carried out after making the leak repair composition 705. The plumbing is reversed from the pump, or a sump system is used with a separate pump with hoses and fittings that fit into the pump or suction line. The composition 705 is then recirculated through the sump so that the composition is run through the line to be repaired. A return line is hooked to the opposite end of the line undergoing repairs, and is then returned back to the sump. The pump is run at 6 pound-force per square inch (psi).

To repair a leaking spa jet, the following process may be carried out after making the leak repair composition 705. The filter media is removed, and a hose is sealed from the air suction line back to the spa. The filter is set for spa only, and enough plugs are placed into the jets so that water will come out of the air suction line and return back to the spa. The composition 705 is then be added to the spa. The spa is then operated for 24 hours and non-operational for three days. Again, the previously removed filter media is replaced and normal operation may resume after it is confirmed that the leak has been fully repaired.

To repair leaking fake rocks, the following process may be carried out after making the leak repair composition 705. The pool is filled to the top of the tile line for repair. The filter media is removed. The composition 705 is then added to the skimmer and suction is set to main drain only. Again, the pool is then operated for 24 hours and non-operational for three days. Again, the previously removed filter media is replaced and normal operation may resume after it is confirmed that the leak has been fully repaired.

To repair copper plumbing, the following process may be carried out before making the leak repair composition 705. Pressure testing is performed for the plumbing before repairs are begun. A recirculating system is set up with a sump. One cup of salt and one cup of muriatic acid are added to the sump of water and the mixture is allowed to recirculate through the pipe for 24 hours. Next, the sump is emptied and flushed out with clean water. Next, the sump system is set up again. Once it is recirculating, the leak repair composition is made and the following process may be carried out. The composition is put into the sump and the sump is operated for approximately 24 hours. Next, the entire system is shut off and left non-operational for approximately 72 hours. Pressure testing is performed again to verify that the plumbing can hold pressure, the system may resume normal operation. If the leak persists, the process outlined above may be repeated.

To repair severe leaks in either copper or PVC pipes, the following process may be carried out before making the leak repair composition 705. Pressure testing is performed for the plumbing before repairs are begun. A recirculating system is set up with a sump. A half cup of sodium bicarbonate is added to the recirculating tank and the recirculating system is operated for one hour. The sump and pipe are then flushed with clean water. Next, the recirculating sump system is set up again with clean water. Then, the leak repair composition 705 is made and the following process may be carried out. The composition 705 is added to the sump, which is run for 24 hours. Next, the entire system is shut off and left non-operational for three days. Pressure testing is performed again to verify that the plumbing can hold pressure, the system may resume normal operation. If the leak persists, the process outlined above may be repeated.

For very large leaks where approximately 5 pounds or more of pressure is lost per minute, a blower may be used after treatment to dry the affected part of the plumbing system. The blower may harden the leak repair composition dramatically, which may enable a weld to a large crack or hole by sealing quicker than when using the leak repair composition alone. If the leak persists, an additional treatment and blower drying may be performed, with allowing the affected area to dry completely between treatments, until the leak is completely sealed.

What follows is a succinct presentation of the experiments conducted to arrive at the compositions and processes disclosed herein. The composition 705 was made according to the processes disclosed above, and tested on copper and PVC pipes. The process for making the composition was tested between 35-115 degrees Fahrenheit and the preparation of the composition appeared to be successful in the range of temperatures tested. Kevlar® and carbon fibers were also mixed with the sodium silicate solution and worked as well as the fiberglass fibers. The composition 405 was tested for the repair of two leaks in pipes. The first repair was for a cut made with a saw blade, approximately 2 inches in length and approximately ⅛ inch in width. The second repair was for a drilled hole approximately ¼ inch in diameter. The composition 705 successfully repaired the leaks caused by the cut and hole. After the repairs were completed, the fibers appeared to have been welded around the hole, creating a thick, strong repair.

Next, another experiment was conducted to test the composition and processes described herein. The composition 705 was made according to the process described when referring to FIG. 5, and tested on a 2 inch PVC pipe with a hole drilled about ¼ inch in diameter, and a 3 inch long slit cut into it, which caused a spray of water approximately 2-3 feet high when the pump is turned on. A recirculating system with a sump was set up for the PVC pipe. “Leak cure part A” was mixed thoroughly with “Leak cure part B,” and dumped into the sump. Next, the recirculating system was operated to move the composition through the pipe. Within a few seconds, the leak was contained about 90%. After running the pump for two hours, the leak was fully stopped. The pump is preferably run for 24 hours in order to ensure a full repair.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A method of repairing a damaged plumbing system, using a composition for repairing leaks, wherein the ratio of a fiber mixture to a sodium silicate solution is about 1 to 7, comprising the steps of:
mixing together the sodium silicate solution and the fiber mixture to make the composition for repairing leaks,
turning on a recirculating pump system,
pouring the composition for repairing leaks into the damaged plumbing system,
operating the recirculating pump system for a first period of time,
shutting off the recirculating pump system, and
allowing the damaged plumbing system to dry for a second period of time.

2. The method of claim 1, wherein the fiber mixture comprises water and fiberglass.

3. The method of claim 2, wherein the first period of time is approximately 24 hours.

4. The method of claim 1, wherein the pouring the composition for repairing leaks into the damaged plumbing system step is accomplished by pouring the composition into a skimmer, and further comprising the steps of:
setting suction of the damaged plumbing system for a main drain, and turning off the skimmer.

5. The method of claim 1, wherein the turning on a recirculating pump system step is accomplished by setting up a recirculating system with a sump, and wherein the pouring the composition for repairing leaks into the damaged plumbing system step is accomplished by pouring the composition into the sump.

6. The method of claim 1, further comprising the step of removing filter media from at least one filter of the damaged plumbing system before turning on a recirculating pump system.

7. The method of claim 2, further comprising the steps of:
blowing air onto the damaged plumbing system, and
allowing the damaged plumbing system to dry fully.

8. The method of claim 7, further comprising the steps of:
verifying that the damaged plumbing system is fully dried,
repeating the steps of pouring the composition for repairing leaks into a skimmer,
turning off the skimmer, setting suction of the damaged plumbing system for a main drain, operating the recirculating pump system, shutting off the recirculating pump system, allowing the damaged plumbing system to dry, blowing air onto the damaged plumbing system, and allowing the damaged plumbing system to dry fully, until the damaged plumbing system is fully repaired.

9. A composition for repairing leaks in plumbing, wherein the ratio of a fiber mixture to a sodium silicate solution is about 1 to 7.

10. The composition of claim 9, wherein the fiber mixture comprises a first quantity of a first size of milled fiberglass and a second quantity of a second size of milled fiberglass.

11. The composition of claim 10, wherein the fiber mixture further comprises water and a third quantity of a third size of chopped fiberglass, and a fourth quantity of glass spheres.

12. The composition of claim 9, wherein the fiber mixture comprises a first quantity of carbon fibers.

13. The composition of claim 9, wherein the fiber mixture comprises a first quantity of wood fibers.

14. The composition of claim 9, wherein the sodium silicate solution is at least 39% diluted in water.

15. The composition of claim 10, further comprising a thickening agent.

16. The composition of claim 15, wherein the thickening agent is thixotropic silica.

17. A method of making a composition for repairing leaks, wherein the ratio of a fiber mixture to a sodium silicate solution is about 1 to 7, comprising the steps of:
providing a first solution comprising the sodium silicate solution,
providing a second solution comprising water and the fiber mixture, the fiber mixture comprising a first quantity of a first size of fibers and a second quantity of a second size of fibers, and
mixing together the first solution and the second solution.

18. The method of claim 17, wherein the first quantity of the first size of fibers is approximately 1 tablespoon of 1/32-inch milled fiberglass, the second quantity of the second size of fibers is approximately 1 tablespoon of 1/32-inch milled fiberglass, and the composition is approximately 32 fluid ounces.

19. The method of claim 18, the fiber mixture further comprising approximately 1 teaspoon of ¼-inch chopped fibers.

20. The method of claim 19, wherein the steps further comprise adding thixotropic silica to the composition, and mixing together the first solution, the second solution, and the thixotropic silica.
